(19) United States
(12) Patent Application Publication
(10) Pub. No.: US 2026/0358775 A1
(43) Pub. Date: Nov. 12, 2026

(54) System and Method for the Supervision and Optimization of Smart Buildings

(71) Applicant: VIDELIO, GENNEVILLIERS (FR)

(72) Inventors: Sebastien JULIA, Clarensac (FR); Frédéric TERRAL, Juvignac (FR)

(73) Assignee: VIDELIO, GENNEVILLIERS (FR)

(21) Appl. No.: 19/671,943

(22) Filed: May 8, 2026

(30) Foreign Application Priority Data
May 9, 2025 (FR) 2504947

(51) Int. Cl. G05B 15/02; H04L 12/28

(52) U.S. Cl. CPC G05B 15/02; H04L 12/282

(57) ABSTRACT

A system for supervising and controlling building equipment that includes audiovisual systems and building management systems. The system includes a server with a web server, a database server and a background processing instance, one or more agents with a processing instance, a message broker, communications between the server, the agents and the building equipment, and data exchanges between the audiovisual systems and the building management systems. The server communicates with the agents via a non-public API to provide a list of equipment to contact and associated parameters. The agents communicate with the equipment and transmit information to the server via the message broker. The message broker facilitates the communication between the agents, the server and a user interface via messaging protocols.

### CROSS-REFERENCE TO RELATED APPLICATION

This application claims the benefit of and priority to French Application number 2504947, filed May 9, 2025, which is incorporated by reference in its entirety.

### FIELD OF THE INVENTION

The present invention relates to a system and a method for supervising and optimizing smart buildings integrating audiovisual equipment and technical management systems.

### CONTEXT OF THE INVENTION

The systems for supervising and controlling buildings have evolved considerably in recent years, integrating more and more functionalities to improve energy efficiency and occupant comfort. These systems generally manage heating, ventilation and air-conditioning (HVAC) equipment, lighting and other technical systems of the building. At the same time, audiovisual equipment has become ubiquitous in modern workspaces, with meeting rooms equipped with screens, videoconferencing systems and other multimedia devices.

However, the integration between the building management systems and the audiovisual equipment remains limited. Existing supervision solutions generally focus on either the building aspect or on the audiovisual aspect, but rarely on both simultaneously. This separation leads to inefficiencies in overall space management, notably in terms of energy optimization and resource use.

A major challenge lies in the heterogeneity of the protocols and standards used by different equipment. Audiovisual systems, in particular, often lack unified standards, which complicates their integration with building management systems. This disparity makes it difficult to collect and consistently interpret data from these different sources.

Furthermore, current space occupancy detection methods often rely on dedicated sensors, without taking advantage of the information potentially available from existing audiovisual equipment. This approach limits the granularity and the accuracy of occupancy data, which can lead to sub-optimal management of energy resources and workspaces.

It has been found that a solution is needed to overcome these limitations. Such a solution should enable seamless integration of audiovisual and building management systems, offer a unified platform for collecting and interpreting data from a variety of sources, and make innovative use of information from existing equipment to improve occupancy detection and resource optimization.

US 2011/219066 discloses a system and a method for managing, routing and controlling equipment.

The document ARJUNAN PANDARASAMY ET AL: "SensorAct: A Decentralized and Scriptable Middleware for Smart Energy Buildings" describes an architecture system notably for developing various energy management applications.

The invention thus aims to provide at least a partial answer to the technical problems presented hereinbefore by proposing a system and a method allowing seamless integration of audiovisual equipment and building management systems. This solution provides a unified platform for collecting and interpreting data from a variety of sources, while making innovative use of information from existing equipment to improve occupancy detection and optimize energy resources.

### BRIEF SUMMARY OF THE INVENTION

In a first aspect, a building equipment supervision and control system is provided. The system comprises: a server, the server comprising a web server, a database server and a background processing instance; one or more agents, each agent comprising a processing instance, a message broker; communication means between the server, the agents and the building equipment; means for exchanging data between audiovisual systems and building management systems, wherein the server is configured to communicate with the agents via a non-public application programming interface (API) to provide the agents with a list of equipment to contact and associated parameters, wherein the agents are configured to communicate with the building equipment and to transmit information and statuses to the server via the message broker, and wherein the message broker is configured to facilitate the communication between the agents, the server and a user interface via messaging protocols.

A web server is a software that responds to requests from web clients, generally browsers, by providing them with resources such as HTML pages. A database server is a system that stores, manages and provides access to data. A background processing instance is a software process that runs in the background to perform tasks without direct user interaction. An agent, in this context, is an autonomous software component that performs specific tasks. A message broker is an intermediary that manages communication between different parts of a distributed system. An API (Application Programming Interface) is a set of definitions and protocols allowing different software programs to communicate with each other.

This configuration offers the advantage of creating a centralized system capable of efficiently managing a wide variety of building equipment, while allowing flexible and secure communication between the various components of the system. The use of distributed agents allows local management of equipment, reducing latency and improving system responsiveness.

According to one embodiment, the communication means may comprise at least one of the following protocols: AMQPS, WEBSOCKET, STOMP, API REST, SNMP, BACnet or Modbus.

AMQPS is a secure messaging protocol. WEBSOCKET is a real-time bidirectional communication protocol. STOMP is a simple text-oriented messaging protocol. API REST is a style of architecture for distributed systems. SNMP is a network management protocol. BACnet is a communication protocol for building automation systems. Modbus is a communication protocol used in industry.

The use of these varied protocols offers great flexibility in communicating with different types of equipment and systems, allowing wider integration and better interoperability within the building.

According to one embodiment, the building equipment may comprise: audiovisual equipment; and/or sensors; and/or access control systems; and/or heating systems; and/or ventilation and air conditioning (HVAC); and/or lighting units.

This diversity of equipment allows comprehensive and integrated management of all aspects of the building, from audiovisual and security to thermal comfort and lighting, thus offering a complete solution for optimizing workspaces.

According to one embodiment, the server can be further configured to communicate directly with remote server platforms of equipment manufacturers via dedicated APIs.

This feature allows further integration with the proprietary systems of manufacturers, offering access to advanced functionalities and data specific to each equipment, which improves the accuracy and the scope of control and supervision.

According to one embodiment, the system may further comprise means for defining customized rules for determining space occupancy based on audiovisual equipment status.

This ability to define customized rules allows more precise occupancy detection tailored to each specific environment, thus improving energy efficiency and space management.

According to one embodiment, the system may further comprise means for integrating reservation information from calendar systems or from space reservation systems.

The integration of reservation information allows better anticipation of space utilization, thus facilitating planning and optimization of building resources.

According to one embodiment, the system can further comprise means for generating automated actions based on the determined occupancy of a space, the actions comprising at least one of the following: lighting control, temperature adjustment, or equipment power supply management.

This automation based on actual occupancy allows more efficient energy management and greater comfort for occupants, while reducing building operating costs.

In a second aspect, a method for determining space occupancy based on audiovisual equipment status is provided. The method, implemented by the system according to the first aspect, comprises: retrieving statuses of audiovisual equipment present in the space; defining rules to determine the occupancy of the space; determining the occupancy of the space based on the retrieved statuses and the defined rules; updating a database with the determined occupancy information; and triggering actions based on the determined occupancy.

The audiovisual equipment statuses can include information such as power status, signal presence or activity level. Occupancy determination rules are logical conditions defined to interpret these statuses in terms of occupancy. A database is an organized system for storing, managing and retrieving information.

This method offers the advantage of determining the occupancy of a space in a non-intrusive way, using equipment already present in the space, without requiring the installation of dedicated presence sensors. This allows for smarter and more economical workspace management.

According to one embodiment, the rules can comprise logical combinations of equipment statuses, including at least one of the following: signal presence on a connection device, power status of a screen, or sound level detected by an audio system.

These logical combinations make occupancy detection more precise and adaptable to different usage scenarios, thus improving the reliability of the system.

According to one embodiment, the method can further integrate data from sensors dedicated to presence detection or people counting.

The addition of this complementary data makes it possible to refine occupancy detection, particularly in situations where the audiovisual equipment alone might not provide a complete picture of space occupancy.

According to one embodiment, the method may further comprise the integration of reservation information from calendar systems or space reservation systems.

This integration makes it possible to correlate actual occupancy with planned reservations, thus offering valuable insights into actual space utilization and facilitating optimization of space management.

According to one embodiment, the actions triggered can comprise at least one of the following: lighting control, temperature adjustment, equipment power supply management, or updating a space availability display system.

These automated actions allow optimized energy management and greater comfort for occupants, while providing real-time information on space availability.

According to one embodiment, the method may further comprise the generation of space utilization reports based on occupancy data collected over a period of time.

These reports provide valuable information for long-term analysis of space utilization, allowing more efficient planning and ongoing optimization of building resources.

In a third aspect, a computer program product comprising instructions for executing the method according to the second aspect is provided, when said program is executed by a computer.

A computer program product is a set of software instructions stored on a computer-readable medium. A computer, in this context, can be any data processing device capable of executing programmed instructions.

This computer program product offers the advantage of easy and standardized implementation of the occupancy determination and space management method on different computer systems.

In a fourth aspect, a use of the system according to the first aspect for building management is provided, comprising optimization of energy consumption based on actual space occupancy.

Optimizing energy consumption involves dynamically adjusting building systems (heating, air conditioning, lighting, etc.) based on the actual occupancy detected.

This significantly reduces energy consumption in buildings, thus contributing to environmental sustainability and lower operating costs, while maintaining an optimum comfort level for occupants.

### BRIEF DESCRIPTION OF THE DRAWINGS

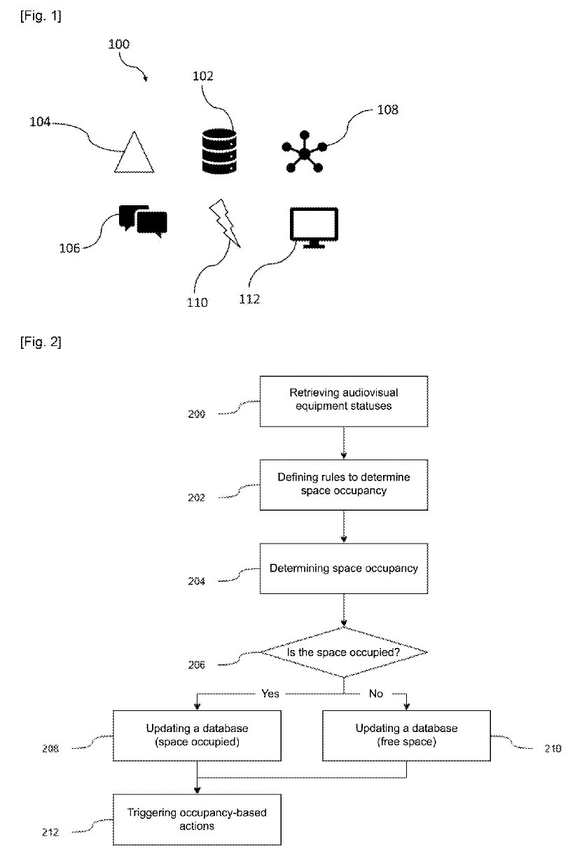

Embodiments of the invention will be disclosed below referring to the drawings, briefly disclosed below:

[FIG. 1] is a block diagram of a building equipment and audiovisual system management system, in accordance with one aspect of the present disclosure; and

[FIG. 2] is a flowchart of an audiovisual equipment status retrieval process for determining and managing space occupancy, in accordance with one aspect of the present disclosure.

### DETAILED DESCRIPTION OF THE INVENTION

The building equipment supervision and control system integrates the audiovisual systems and the building management systems into a unified solution. This system comprises a server, one or more agents, a message broker, communication means and data exchange means. The flexible architecture of the system allows its deployment on the customer's local network or in a SaaS environment, thus offering installation options tailored to the specific needs of each user.

Integrating audiovisual systems with traditional building management systems creates a centralized control platform, allowing more efficient management and optimization of resources in modern workspaces.

The building equipment supervision and control system 100 comprises several main components, shown in FIG. 1.

A server 102 forms the heart of the system 100. The server 102 comprises an Apache web server, a PHP server, a MariaDB database and a background processing instance. This architecture allows the server 102 to manage web requests, process data and store said data efficiently.

One or more agents 104 are deployed in the system 100. Each agent 104 comprises a processing instance, generally based on Node.js. The agents 104 are installed on the customer's local network and are configured to communicate with the building equipment. The agents 104 collect information and statuses from the equipment, then transmit these data to the server 102.

A message broker 106 facilitates the communication between the various components of the system 100. The message broker 106 uses RabbitMQ, a robust messaging technology. The message broker 106 is configured to facilitate the communication between the agents 104, the server 102, and a user interface via various messaging protocols. The message broker 106 is installed either on the server 102, or on an independent server, thus offering flexibility in the architecture of the system.

Communication between the server 102 and the agents 104 takes place in two ways. Firstly, the server 102 is configured to communicate with the agents 104 via a non-public API. This API allows the server 102 to provide the agents 104 with a list of equipment to be contacted and associated parameters. Secondly, the agents 104 transmit the collected information and statuses to the server 102 via the message broker 106.

This architecture allows efficient and flexible management of building equipment, by ensuring fluid communication between the various components of the system 100.

The system 100 comprises communication means 108 and data exchange means 110 that allow integration and interoperability between the audiovisual systems and the building management systems.

The communication means 108 use a variety of protocols to facilitate the communication between the various components of the system 100. These protocols include AMQPS, WEBSOCKET, STOMP, API REST, SNMP, BACnet and Modbus. The use of these protocols allows flexible and robust communication between the server 102, the agents 104 and the building equipment.

The communication means 108 also support Lora, Dante, IP and GSM protocols, thus extending the range of devices and systems that can be integrated into the system 100. This diversity of protocols allows the system 100 to communicate effectively with a wide range of building equipment, comprising sensors, access control systems, HVAC systems and lighting units.

The data exchange means 110 facilitate the transfer of information between the audiovisual systems and the building management systems. These data exchange means 110 allow a consistent interpretation and use of data from various sources, independently of the original protocol.

The server 102 is configured to communicate directly with remote server platforms of equipment manufacturers via dedicated APIs. This feature allows the system 100 to integrate data from external sources, thus enriching the supervision and control capabilities of the system.

The combined use of communication means 108 and data exchange means 110 allows the system 100 to create a unified environment where data from audiovisual systems and building management systems can be accessed, interpreted and used seamlessly for the supervision, control and slaving operations.

The system 100 comprises a user interface 112 that enables users to interact with the system and access its advanced functionalities. The user interface 112 provides means for defining customized rules in order to determine space occupancy based on the statuses of audiovisual equipment. For example, the user interface 112 makes it possible to configure rules based on the presence of a signal on a connection device, the power status of a screen, or the sound level detected by an audio system.

The system 100 integrates information from sensors integrated into audiovisual equipment, such as videoconferencing bars. These sensors provide additional data to refine occupancy detection. The rules for determining space occupancy include volume level thresholds detected by an audio DSP, thus making it possible to detect the presence of people even when the audiovisual equipment is not actively in use.

The user interface 112 also offers functionalities for integrating reservation information from calendar systems or space reservation systems. This integration correlates actual occupancy data with planned reservations, thus offering a complete view of space utilization.

The system 100 comprises means for generating automated actions based on the determined occupancy of a space. These automated actions comprise lighting control, temperature adjustment and equipment power supply management. For example, when a space is detected as unoccupied, the system 100 can automatically switch off the lights, reduce the air-conditioning temperature and put certain audiovisual equipment on standby to optimize energy consumption.

The user interface 112 allows system administrators to configure and customize these automated actions based on the specific needs of each space or building. The users can define complex scenarios combining several conditions and actions, thus offering great flexibility in the management of spaces and equipment.

FIG. 2 shows a method for determining space occupancy based on audiovisual equipment status.

The method begins by retrieving the status of audiovisual equipment 200 present in the space. This step consists of collecting status information from the various audiovisual equipment installed in the space, such as the screens, the videoconferencing systems, the connection devices or the audio systems.

Next, rules are defined to determine the occupancy of the space 202. These rules comprise logical combinations of equipment statuses. For example, a rule might stipulate that a space is considered occupied if a signal is present on a connection device AND if the screen is switched on. Another rule may consider the space occupied if the sound level detected by the audio system exceeds a certain threshold.

The method continues with a determination of the occupancy of the space 204, 206 based on the statuses retrieved and the rules defined. This step applies the rules to the collected statuses to assess whether the space is occupied or not.

Depending on the result of this determination, the method updates a database 208, 210. If the space is determined as occupied, a database update (occupied space) 208 is performed. If this is not the case, a database update (free space) 210 is performed. This database centralizes the occupancy information for all supervised spaces.

The method ends by triggering actions based on the occupancy 212. These actions can include controlling the lighting, adjusting the temperature, managing the equipment power supply, or updating a space availability display system.

The method also integrates reservation information from calendar systems or space reservation systems. This information is taken into account when determining occupancy, allowing more precise space management.

In addition, the method allows the integration of data from sensors dedicated to presence detection or people counting. This additional data refines the determination of occupancy, notably in cases where the audiovisual equipment is not used but the space is occupied.

The system 100 for supervising and controlling building equipment is shown in FIG. 1. The system 100 comprises a server 102, one or more agents 104, a message broker 106, communication means 108, data exchange means 110, and a user interface 112.

The server 102 includes a web server, a database server and a background processing instance. The server 102 communicates with the agents 104 via a non-public application programming interface (API) to provide agents 104 with a list of equipment to contact and associated parameters.

The agents 104 are installed on the customer's local network and communicate with the building equipment. The agents 104 transmit the information and statuses to the server 102 via the message broker 106.

The message broker 106 facilitates the communication between the agents 104, the server 102 and the user interface 112 using various messaging protocols. The communication means 108 allow the exchange of data between the various components of the system.

The data exchange means 110 ensure the interoperability between the audiovisual systems and the building management systems, thus allowing integrated supervision and control.

The user interface 112 offers users access to the supervision and control functionalities of the system.

FIG. 2 shows the method for determining space occupancy based on the statuses of audiovisual equipment. The method begins with a status retrieval step for audiovisual equipment 200. Next, a step of defining rules for determining the occupancy of the space 202 establishes the evaluation criteria.

The step of determining the occupancy of the space 204 applies these rules to the retrieved statuses. A decision is made during the step of determining the occupancy of the space 206. If the space is occupied, a database update (space occupied) 208 is performed. If this is not the case, a database update (free space) 210 is performed.

The method ends with a step 212 of triggering actions based on occupancy, where automated actions are executed based on the determined occupancy state.

The system 100 generates space utilization reports based on the occupancy data collected over a period of time. These reports provide valuable information for optimizing the management of building space and resources.

A computer program product comprises instructions for executing the occupancy determination and equipment management method. This program product automates supervision and control processes, thus improving the efficiency of building management.

The system 100 is used for building management, notably for optimizing energy consumption based on actual space occupancy. By integrating the data from audiovisual and building management systems, the system 100 allows more precise and efficient management of building resources.

It should be appreciated that the concepts, systems, circuits and techniques whose protection is sought herein are not limited to the exemplary applications disclosed in the present document (for example, the industrial applications), but can be useful in virtually any application where it is desirable to receive decision support for every step in an automated way. Although particular embodiments and applications of the present disclosure have been shown and disclosed in connection with building management and the real estate industry, it should be understood that the embodiments of the disclosure are not limited to the precise construction and compositions disclosed herein and that various modifications, changes and variations may be apparent from the foregoing descriptions without departing from the spirit and scope of the disclosure as defined in the appended claims.

Although exemplary embodiments of the invention have been disclosed, it will be understood by a person skilled in the art that various changes, omissions and/or additions may be made, and that equivalents may be substituted for elements without departing from the spirit and scope of the invention. Additionally, numerous modifications can be made to adapt a particular situation or a material to the teachings of the invention without departing from the scope thereof. As a result, it is intended that the invention is not limited to the particular embodiments disclosed for implementing this invention, but that the invention will include all the embodiments falling within the scope of the appended claims. Furthermore, unless specified otherwise, any use of the terms first, second, etc., does not denote any order or importance, but these terms first, second, etc., are used to distinguish one element from another.

1. A system (100) for supervising and controlling building equipment comprising audiovisual systems and building management systems, comprising:
a server (102), the server comprising a web server, a database server and a background processing instance;
one or more agents (104), each agent comprising a processing instance,
a message broker (106);
communication means (108) between the server, the agents and the building equipment;
data exchange means (110) between the audiovisual systems and the building management systems,
wherein the server (102) is configured to communicate with the agents (104) via a non-public application programming interface (API) to provide the agents (104) with a list of equipment to contact and associated parameters,
wherein the agents (104) are configured to communicate with the building equipment and to transmit information and statuses to the server (102) via the message broker (106), and
wherein the message broker (106) is configured to facilitate the communication between the agents (104), the server (102), and a user interface (112) via messaging protocols.

2. The system (100) according to claim 1 wherein the communication means (108) comprise a communication protocol such as: AMQPS, WEBSOCKET, STOMP, API REST, SNMP, BACnet or Modbus.

3. The system (100) according to claim 1 wherein the building equipment comprises: audiovisual equipment; and/or sensors; and/or access control systems; and/or heating, ventilation and air conditioning (HVAC) systems; and/or lighting units.

4. The system (100) according to claim 1 wherein the server (102) is further configured to communicate directly with remote server platforms of equipment manufacturers via dedicated APIs.

5. The system (100) according to claim 1 further comprising means for defining customized rules for determining space occupancy based on audiovisual equipment status.

6. The system (100) according to claim 5, further comprising means for integrating reservation information from calendar systems or space reservation systems.

7. The system (100) according to claim 5, further comprising means for generating automated actions based on the determined occupancy of a space, the actions comprising at least one of the following: lighting control, temperature adjustment or equipment power supply management.

8. The system (100) according to claim 1 wherein the message broker (106) uses RabbitMQ.

9. The system (100) according to claim 1 wherein each agent (104) comprises a Node.js-based processing instance.

10. The system (100) according to claim 1 wherein the communication means (108) support Lora, Dante, IP or GSM protocols.

11. A method for determining space occupancy based on audiovisual equipment statuses, implemented by the system (100) according to claim 1 comprising: • retrieving statuses of audiovisual equipment (200) present in the space;• defining rules to determine the occupancy of the space (202);• determining the occupancy of the space (204, 206) based on the statuses retrieved and the rules defined;• updating a database (208, 210) with the determined occupancy information; and• triggering actions (212) based on the determined occupancy.

12. The method according to claim 11, wherein the rules comprise logical combinations of equipment statuses, including at least one of the following: signal presence on a connection device, power status of a screen, or sound level detected by an audio system.

13. The method according to claim 11, further comprising the integration of data from sensors dedicated to presence detection or people counting.

14. The method according to claim 11, further comprising the integration of reservation information from calendar systems or space reservation systems.

15. The method according to claim 11, wherein the actions triggered comprise at least one of the following: lighting control, temperature adjustment, equipment power supply management or updating a space availability display system.

16. The method according to claim 11, further comprising the generation of space utilization reports based on the occupancy data collected over a period of time.

17. A non-transitory computer-readable medium comprising instructions for executing the method according to claim 11 when said instructions are executed by a computer.

18. The non-transitory computer-readable medium according to claim 11, wherein the rules comprise logical combinations of equipment statuses.

19. The non-transitory computer-readable medium according to claim 17, wherein the actions triggered comprise at least one of the following: lighting control, temperature adjustment or equipment power management.

20. Use of the system (100) according to claim 1 for building management, comprising optimizing energy consumption based on actual space occupancy.
